(19) United States
(12) Patent Application Publication
(10) Pub. No.: US 2017/0199796 A1
(43) Pub. Date: Jul. 13, 2017

(54) DATA STORAGE, RETREIVAL AND ANALYSIS SYSTEMS FOR MONITORING GEOGRAPHICALLY DISTRIBUTED ELECTROMECHANICAL SYSTEMS

(71) Applicants: Chris Chaput, Portland, OR (US); Jeffery Lassahn, Portland, OR (US)

(72) Inventors: Chris Chaput, Portland, OR (US); Jeffery Lassahn, Portland, OR (US)

(21) Appl. No.: 14/990,997

(22) Filed: Jan. 8, 2016

(51) Int. Cl. G06F 11/30; H04L 29/08

(52) U.S. Cl. CPC G06F 11/3006; H04L 67/10

(57) ABSTRACT

Network-based systems for monitoring geographically distributed electromechanical equipment, such as a supermarket refrigerator case or walk-in freezer. Systems includes a number of monitored sites, each in data communication with a separate data analysis facility, each facility in turn with its own data storage. All data analysis facilities are in communication with an interface server, which provides site owners/operators access to data and analyses on the various monitored sites. In some examples, data analysis facilities carry out analysis only, with data storage being consolidated into a single data storage facility that is in communication with the interface server.

### BACKGROUND

The present disclosure relates generally to remote monitoring of electromechanical equipment. In particular, systems for remote data storage, retrieval and analysis of electromechanical systems that are potentially geographically distributed, such as refrigeration units or freezers installed in various sites like supermarkets or restaurants, which can be implemented in a cloud-service basis are described.

Known systems for data storage, retrieval and analysis of electromechanical systems are not entirely satisfactory for the range of applications in which they are employed. For example, existing systems typically are implemented physically proximate to the electromechanical systems being monitored. Such an implementation may require costly equipment to be located on the monitored site, with its commensurate costs of maintenance and service. Other disadvantages include the potential inefficiency of using a dedicated on-site server or servers where the monitored equipment is comparatively small, the potential lack of redundancy where only a single server can be justified, and the possibility of intermittent or inconsistent remote access to status information and analyses of the monitored systems.

Thus, there exists a need for systems for data storage, retrieval and analysis of electromechanical equipment that improve upon and advance the design of known electromechanical equipment monitoring systems. Examples of new and useful systems relevant to the needs existing in the field are discussed below.

### SUMMARY

The present disclosure is directed to a network-based system for monitoring electromechanical equipment, such as a supermarket refrigerator case or wlk-in freezer. The system includes a number of monitored sites, each in data communication with a separate data analysis facility, each facility in turn with its own data storage. All data analysis facilities are in communication with an interface server, which provides site owners/operators access to data and analyses on the various monitored sites. In some examples, each data analysis facility carries out analysis only, with data storage being consolidated into a single data storage facility that is in communication with the interface server.

### BRIEF DESCRIPTION OF THE DRAWINGS

FIG. 1 shows a schematic view of an example of a programmable computing device.

FIG. 2 shows a schematic view of an example of a mobile electronic device.

FIG. 3 is a diagram view of a first example of a data storage, retrieval and analysis system for monitoring geographically distributed electromechanical systems.

FIG. 4 is a diagram view of a second example of a data storage, retrieval and analysis system for monitoring geographically distributed electromechanical systems including an alternative configuration for a data storage facility.

FIG. 5 is a diagram of the HDF file structure use in the data storage, retrieval and analysis system of FIG. 3 including raw data files and derived data files.

### DETAILED DESCRIPTION

The disclosed systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

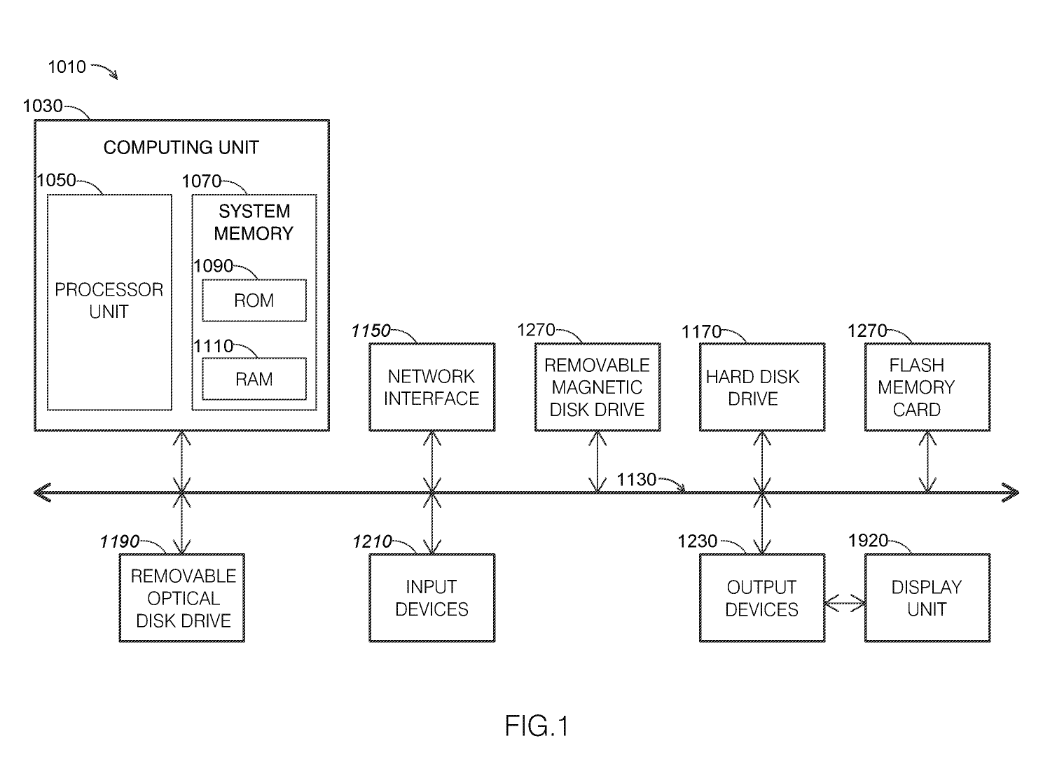

Accordingly, FIG. 1 shows one illustrative example of a computer, computer 1010, which can be used to implement various embodiments of the invention. Computer 1010 may be incorporated within a variety of consumer electronic devices, such as personal media players, cellular phones, smart phones, personal data assistants, global positioning system devices, and the like, or may comprise a standalone personal computing device, such as a desktop computer, a laptop, a tablet computer, or a hybrid computing device.

As seen in this figure, computer 1010 has a computing unit 1030. Computing unit 1030 typically includes a processing unit 1050 and a system memory 1070. Processing unit 1050 may be any type of processing device for executing software instructions, but will conventionally be a microprocessor device. System memory 1070 may include both a read-only memory (ROM) 1090 and a random access memory (RAM) 1110. As will be appreciated by those of ordinary skill in the art, both read-only memory (ROM) 1090 and random access memory (RAM) 1110 may store software instructions to be executed by processing unit 1050.

Processing unit 1050 and system memory 1070 are connected, either directly or indirectly, through a bus 1130 or alternate communication structure to one or more peripheral devices. For example, processing unit 1050 or system memory 1070 may be directly or indirectly connected to additional memory storage, such as a hard disk drive 1170, a removable optical disk drive 1190, a removable magnetic disk drive 1250, and a flash memory card 1270. Processing unit 1050 and system memory 1070 also may be directly or indirectly connected to one or more input devices 1210 and one or more output devices 1230. Input devices 1210 may include, for example, a keyboard, touch screen, a remote control pad, a pointing device (such as a mouse, touchpad, stylus, trackball, or joystick), a scanner, a camera or a microphone. Output devices 1230 may include, for example, a monitor display, an integrated display, television, printer, stereo, or speakers.

Still further, computing unit 1030 will be directly or indirectly connected to one or more network interfaces 1150 for communicating with a network. This type of network interface 1150 is also sometimes referred to as a network adapter or network interface card (NIC). Network interface 1150 translates data and control signals from computing unit 1030 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 1150 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 1010 may be connected to a digital music player, such as an IPOD® brand digital music player or iOS or Android based smartphone. As known in the art, this type of digital music player can serve as both an output device for a computer (e.g., outputting music from a sound file or pictures from an image file) and a storage device.

In addition to a digital music player, computer 1010 may be connected to or otherwise include one or more other peripheral devices, such as a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 1010 so that their data maintained may be synchronized.

Of course, still other peripheral devices may be included with or otherwise connected to a computer 1010 of the type illustrated in FIG. 1, as is well known in the art. In some cases, a peripheral device may be permanently or semi-permanently connected to computing unit 1030. For example, with many computers, computing unit 1030, hard disk drive 1170, removable optical disk drive 1190 and a display are semi-permanently encased in a single housing.

Still other peripheral devices may be removably connected to computer 1010, however. Computer 1010 may include, for example, one or more communication ports through which a peripheral device can be connected to computing unit 1030 (either directly or indirectly through bus 1130). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 1010 may include a wireless data “port,” such as a Bluetooth® interface, a Wi-Fi interface, an infrared data port, or the like.

It should be appreciated that a computing device employed according to the various examples of the invention may include more components than computer 1010 illustrated in FIG. 1, fewer components than computer 1010, or a different combination of components than computer 1010. Some implementations of the invention, for example, may employ one or more computing devices that are intended to have a very specific functionality, such as a digital music player or server computer. These computing devices may thus omit unnecessary peripherals, such as the network interface 1150, removable optical disk drive 1190, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

In many examples, computers may define mobile electronic devices, such as smartphones, tablet computers, or portable music players, often operating the iOS, Symbian. Windows-based (including Windows Mobile and Windows 8), or Android operating systems.

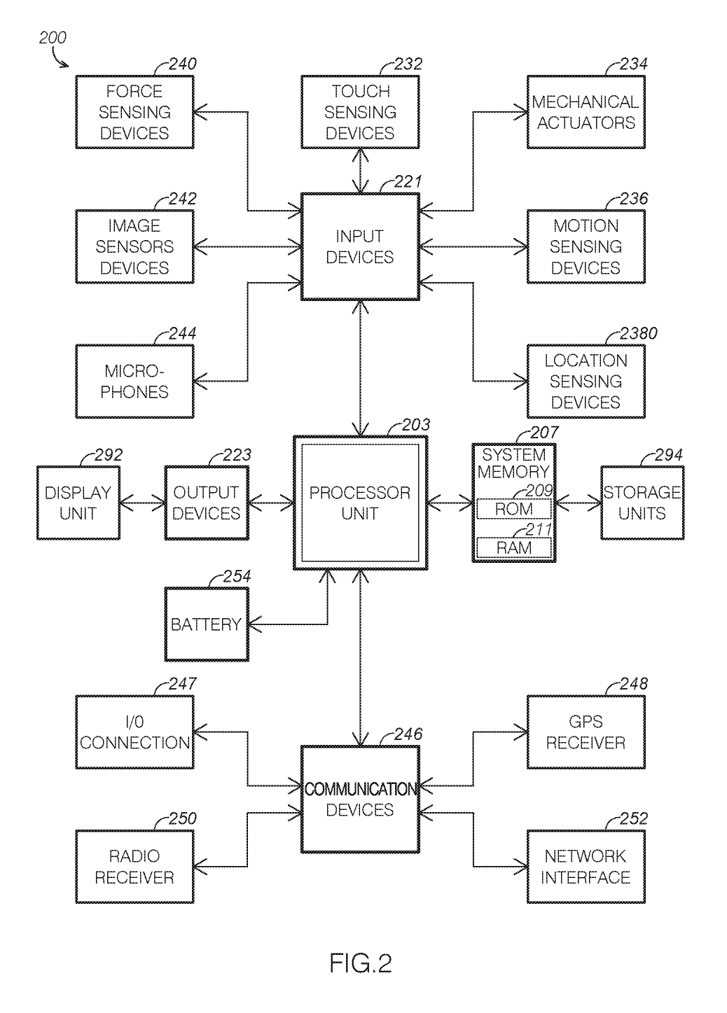

With reference to FIG. 2, an exemplary mobile device, mobile device 200, may include a processor unit 203 (e.g., CPU) configured to execute instructions and to carry out operations associated with the mobile device. For example, using instructions retrieved from memory, the controller may control the reception and manipulation of input and output data between components of the mobile device. The controller can be implemented on a single chip, multiple chips or multiple electrical components. For example, various architectures can be used for the controller, including dedicated or embedded processor, single purpose processor, controller, ASIC, etc. By way of example, the controller may include microprocessors, DSP, A/D converters, D/A converters, compression, decompression, etc.

In most cases, the controller together with an operating system operates to execute computer code and produce and use data. The operating system may correspond to well-known operating systems such as iOS, Symbian, Windows-based (including Windows Mobile and Windows 8), or Android operating systems, or alternatively to special purpose operating system, such as those used for limited purpose appliance-type devices. The operating system, other computer code and data may reside within a system memory 207 that is operatively coupled to the controller. System memory 207 generally provides a place to store computer code and data that are used by the mobile device. By way of example, system memory 207 may include read-only memory (ROM) 209, random-access memory (RAM) 211, etc. Further, system memory 207 may retrieve data from storage units 294, which may include a hard disk drive, flash memory, etc. In conjunction with system memory 207, storage units 294 may include a removable storage device such as an optical disc player that receives and plays DVDs, or card slots for receiving mediums such as memory cards (or memory sticks).

Mobile device 200 also includes input devices 221 that are operatively coupled to processor unit 203. Input devices 221 are configured to transfer data from the outside world into mobile device 200. As shown, input devices 221 may correspond to both data entry mechanisms and data capture mechanisms. In particular, input devices 221 may include the following: touch sensing devices 232 such as touch screens, touch pads and touch sensing surfaces; mechanical actuators 234 such as button or wheels or hold switches; motion sensing devices 236 such as accelerometers; location detecting devices 238 such as global positioning satellite receivers, WiFi based location detection functionality, or cellular radio based location detection functionality; force sensing devices 240 such as force sensitive displays and housings; image sensors 242; and microphones 244. Input devices 221 may also include a clickable display actuator.

Mobile device 200 also includes various output devices 223 that are operatively coupled to processor unit 203. Output devices 223 are configured to transfer data from mobile device 200 to the outside world. Output devices 223 may include a display unit 292 such as an LCD, speakers or jacks, audio/tactile feedback devices, light indicators, and the like.

Mobile device 200 also includes various communication devices 246 that are operatively coupled to the controller. Communication devices 246 may, for example, include both an I/O connection 247 that may be wired or wirelessly connected to selected devices such as through IR, USB, or Firewire protocols, a global positioning satellite receiver 248, and a radio receiver 250 which may be configured to communicate over wireless phone and data connections. Communication devices 246 may also include a network interface 252 configured to communicate with a computer network through various means which may include wireless connectivity to a local wireless network, a wireless data connection to a cellular data network, a wired connection to a local or wide area computer network, or other suitable means for transmitting data over a computer network.

Mobile device 200 also includes a battery 254 and possibly a charging system. Battery 254 may be charged through a transformer and power cord or through a host device or through a docking station. In the cases of the docking station, the charging may be transmitted through electrical ports or possibly through an inductance charging means that does not require a physical electrical connection to be made.

The various aspects, features, embodiments or implementations of the invention described above can be used alone or in various combinations. The methods of this invention can be implemented by software, hardware or a combination of hardware and software. The invention can also be embodied as computer readable code on a computer readable medium. The computer readable medium is any data storage device that can store data which can thereafter be read by a computer system, including both transfer and non-transfer devices as defined above. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

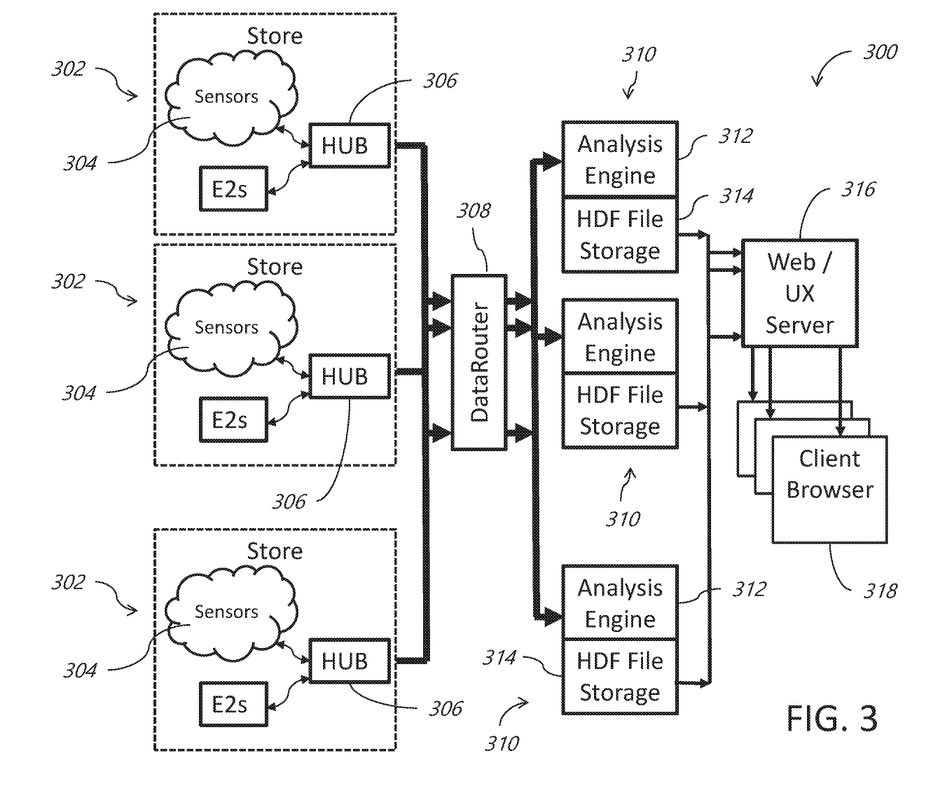

With reference to FIG. 3, a first example of a data storage, retrieval and analysis system for monitoring geographically distributed electromechanical equipment, system 300, will now be described. System 300 functions to provide cloud-based monitoring and analysis of the status of various geographically distributed sites that typically implement electromechanical systems, such as refrigeration cases or freezers. The reader will appreciate from the figures and description below that system 300 addresses shortcomings of conventional systems for analysis and monitoring of electromechanical equipment.

For example, system 300 allows for economies of scale, by employing a cloud-based model to implement analysis and storage of data received from monitored sites. Data centers typically employ such technologies as virtualization, which allows using a single or few physical server hardware boxes to implement a greater number of logical servers. As is known in the art, this technology allows for substantially greater efficiency and utilization of server hardware, by minimizing possible hardware idle time. Virtualization also allows for quick spin-up and scalability of analysis and storage facilities, thereby enabling good response times to additional customers and/or monitored sites coming on-line.

Furthermore, implementing system 300 in a cloud-based fashion provides for easy remote access and monitoring of electromechanical equipment sites. Where system 300 is preferably implemented using Internet-accessible servers, owners/operators of sites can have instant access to the status of their sites and associated equipment at any time, from virtually anywhere in the world.

Finally, a cloud-based implementation of system 300 typically saves money while improving overall uptime, as the operator of system 300, rather than the owner/operator of a site with electromechanical equipment, is responsible for system maintenance.

As can be seen in FIG. 3, system 300 comprises one or more sites 302 with monitored systems. Each site 302 further has one or more sensors 304 attached to the monitored systems, and at least one hub 306 in data communication with the one or more sensors. Hub 306 in turn is in data communication with a data router 308, which itself is in data communication with one or more data analysis facilities 310. An interface server 316 is in data communication with the one or more data analysis facilities 310 and thus provides access to the data analysis performed by each data analysis facility 310 via a client browser 318.

Each site 302 is typically a single geographically distinct location with at least one hub 306, and an associated data analysis facility 310. While the preferred implementation of system 300 has at least one hub 306 and one data analysis facility 310 associated with each site 302, multiple hubs 306 can potentially be associated with a single site 302 and a single data analysis facility 310. It further may be possible if user needs dictate to associate a single hub 306 with multiple geographic sites and potentially multiple data analysis facilities 310. Each site 302 has one or more installed electromechanical systems to be monitored, such as a walk-in freezer or refrigerator as might be employed in a restaurant, a large freezer or refrigerator case as employed in a supermarket or grocery store, or a refrigeration system that may be employed in a warehouse. However, the disclosed system could potentially be used with any other type of system that lends itself to monitoring by sensors, and that is preferably continuously monitored due to a mission-critical nature. Electromechanical equipment to be monitored may include such devices as compressors, condensers, electronically operated or controlled vales, and other similar devices as may be employed in an electromechanical system that are now known or later developed and subject to periodic or continuous monitoring.

Sensors 304 are selected based upon the nature of the system in a site 302 that is to be monitored. For example, where the system to be monitored is electromechanical, such as a refrigerator case or freezer, sensors 304 may detect and monitor parameters such as line voltage, current draw, line frequency, startup time, voltage and current spikes, motor temperature, refrigerant pressure, temperature of the refrigerated cavity, and/or any other electrical or physical property that would assist in determining the status of the monitored system. The monitored parameters preferably would allow early detection of impending failures, indicate needed maintenance, or alert the operator of site 302 of failures to allow moving or relocating any associated items to avoid damage or spoilage. Other potentially relevant parameters to monitor and measure may include water pressure, temperature and flow, where the monitored system uses water (such as a boiler), or battery run time, cycles, voltage, and charge status, where the monitored system relies upon batteries for power storage. Still further possible monitored parameters include any physical attribute that is subject to change, and can be monitored by one or more sensors 304.

Sensors 304 output data that can be quantized and converted into a digital format. Sensors 304 preferably take measurements of their assigned parameters at a sample rate sufficiently high so as to detect faults within the range of possible failure modes of the monitored equipment. Depending upon the type of sensor 304, supporting circuitry such as analog to digital converters, power supplies and/or controllers may be required as part of sensor 304.

In the example shown in FIG. 3, hub 306 serves to locally collect data from the various sensors 304 and transmit it via a data connection for further processing. Where necessary, hub 306 can also include storage functionality that can act to buffer sensor data until transmission. Such functionality can be useful where bandwidth is limited or expensive. In some implementations hub 306 may include the aforementioned supporting circuitry that is specific to various types of sensors 304. Hub 306 can receive data from sensors 304 by any suitable technology now known or later developed, including direct connection, USB, Firewire, Infrared transmission, or other wired or wireless networking technology. Hub 306 may transmit data via a network interface, hardware cable such as USB, Firewire, Thunderbolt, or any communications technology now known or later developed. Such technologies can also include WiFi, cellular, hardwire networks such as Ethernet or fiber optics. Site 302 can have one or more hubs 306 depending upon the needs of site 302 and its operator.

Hub 306 is in data communication with a data router 308, to which it transfers data collected from sensors 304. As depicted in FIG. 3, data router 308 may be implemented on a one-to-many basis, where multiple hubs 306 connect to a single data router 308. Alternatively, depending on the needs of a particular implementation of system 300, there may be a single data router 308, or data router 308 may be bypassed entirely, with hub 306 communicating directly to data analysis facility 310. Furthermore, depending upon the complexity of a particular implementation of system 300, there may be multiple data routers 308 that are interconnected. Data router 308 acts to route data from hub 306 to the appropriate data analysis facility or facilities 310 that is/are associated with hub 306. Data router 308 can be implemented using any known or later developed technology for routing data between multiple points. Examples of such equipment include routers made by Cisco Systems, Dell, HP, or other similar companies. Hub 306 preferably communicates with data router 308 using technologies such as TCP/IP, such as the protocols employed over the Internet, although any known or later developed technologies for accurately transmitting data may be employed. Data router 308 may be interconnected with and communicate with hub 306 over the Internet, a private wide-area network, a local-area network, or a direct connection.

To maintain system integrity in implementations that have multiple customers/site operators utilizing a single system 300, each hub 306 preferably authenticates itself to data router 308, and on the basis of credentials supplied from hub 306, data router 308 determines the appropriate data analysis facility 310 to which to route data from hub 306. The credentials supplied by hub 306 are preferably determined while system 300 is being set up for a site operator. Where hub 306 talks directly to data analysis facility 310, the credentials are supplied directly to data analysis facility 310, which handles authentication. Furthermore, where hub 306 fails to supply credentials to either data router 308 or data analysis facility 310, as appropriate, that match the predetermined credentials, data router 308 or data analysis facility 310 will refuse to receive data from hub 306.

Each data analysis facility 310 is further comprised of an analysis engine 312 associated with one of the one or more sites, and a data storage facility 314 corresponding to and in data communication with the analysis engine 312. In the preferred embodiment, analysis engine 312 is responsible for receiving data received from sensors 304 via data router 308 and place into data storage facility 314. Analysis engine 312 acts to retrieve and analyze data received from sensors 304 to aid in monitoring efforts of the operator of site 302. The types of analysis performed will depend upon the particular needs of the operator of site 302. Analysis engine 312 can be preprogrammed with various types of standard analyses based upon the nature of site 302, with the option to create customized analyses. In the context of refrigeration, such preprogrammed analyses may include detection of electrical faults, determining whether the power profile (changes over time of voltage and current draw) of a motor startup is deviating from a normal startup range, or detection of excessive deviations from a temperature set point. Analyses may also be tailored to the particular make and model of a system, to take into account operational parameters that will vary from manufacture to manufacturer and model to model.

Although data analysis facility 310 is depicted in FIG. 3 as a single entity, this is for logical purposes only. The constituent components of data analysis facility 310, analysis engine 312 and data storage facility 314, can be practically implemented on a single, stand-alone server, or on a cluster of servers. When implemented across multiple servers, analysis engine 312 and data storage facility 314 can be executed on separate machines. Alternatively, analysis engine 312 and data storage facility 314 can be executed in a combined fashion on a single server, with multiple servers (and hence multiple instances of analysis engine 312 and data storage facility 314) being combined to form a computing cluster, such as may be found in a data center. Other implementations of data analysis facility 310 may be effected as now known or later developed in the relevant art without departing from the disclosed invention.

Analysis engine 312 is preferably implemented as a software module that is capable of being executed by a computer 1010. Analysis engine 312 can be implemented as a standalone process or program, or as part of a larger software package, and is ideally implemented so as to allow for customization of the types of analysis capable of being performed. Furthermore, analysis engine 312 can be implemented in a variety of ways known in the relevant art: as a single process or multiple processes that run on a single computing platform where each process in turn can have a single or multiple threads of execution, as a process or processes that run on multiple computing platforms such as a cloud system or clustered server group, or any other implementation now known or later developed. In still other example implementations, multiple analysis engines 312 could be executed on a single computing platform.

In FIG. 3, analysis engine 312 is in communication with a data storage facility 314, where analysis engine 312 acts to both store and retrieve data from data storage facility 314. As suggested in FIG. 3, data storage facility 314 can be integrated with analysis engine 312 into a single software package, or can be implemented as a stand-alone process that is separate from analysis engine 312. Data storage facility 314 acts to store all raw information that is received by data analysis facility 310 via analysis engine 312 from data router 308, and also the various analyses performed by analysis engine 312. In some alternative embodiments, data storage facility 314 could receive and store data directly from hubs 306 or data router 308; in such implementations, analysis engine 312 would retrieve all data from data storage facility 314 and store the resulting analyses back to data storage facility 314. In such alternative embodiments data storage facility 314 may be separate from analysis engine 312. Data storage facility 314 may store received data and analyses on a hard drive, flash storage, RAID array, SAN storage equipment, or potentially offline or near line storage systems such as tape backup, as needs of system 300 dictate. Moreover, a combination of any of the above may be utilized as appropriate.

Data storage facility 314 is preferably implemented as a set of reader and writer processes or threads, with the number of each reader and writer threads being executed at any given time potentially varying depending upon system load. These processes may be stand-alone. Alternatively, writing functionality may be incorporated into analysis engine 312, which will thus handle the writing of raw data and analyses. Furthermore, reading may also be accomplished by analysis engine 312, and further still, a separate reading process may coexist that is dedicated to supplying data to interface server 316 apart from analysis engine 312.

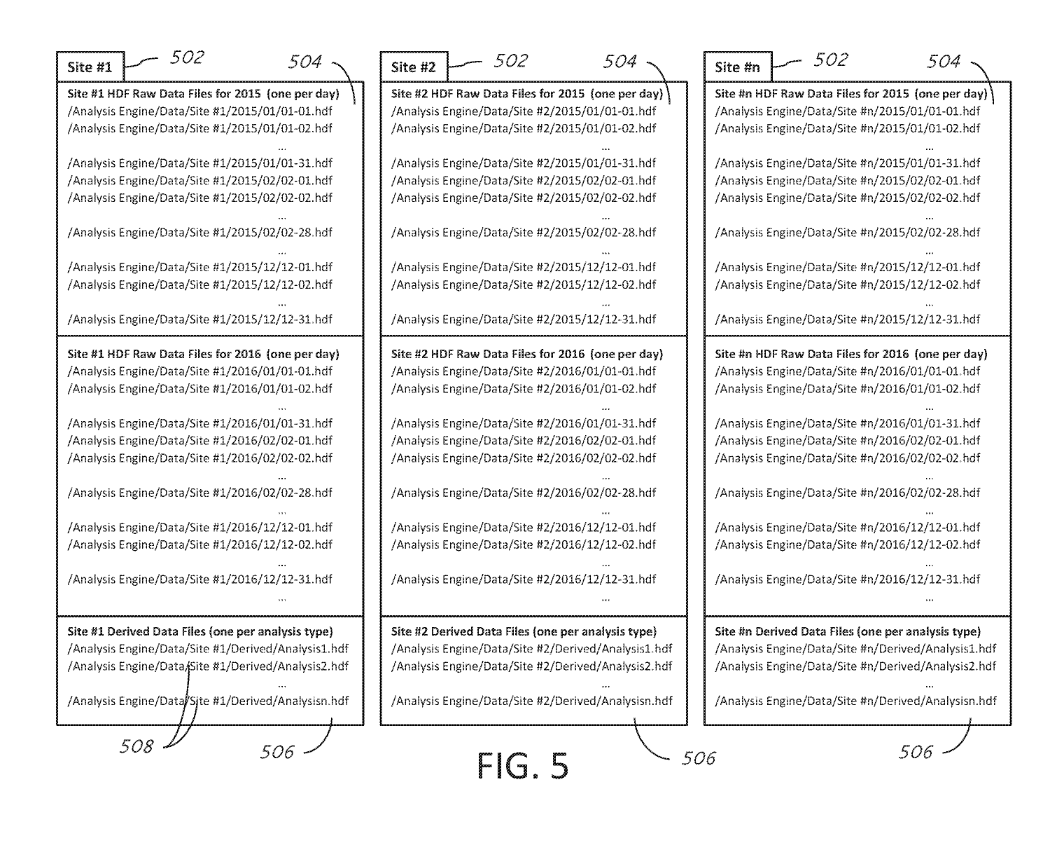

Data storage facility 314 preferably stores data using the Hierarchical Data Format (“HDF”), as described at: www.hdfgroup.org, such as the HDF4 or HDF5 format. The disclosures found at www.hdfgroup.org are hereby incorporated by this reference in their entirety. HDF files and their supporting libraries and utilities are particularly suited for storage and access of large data sets, and accordingly are well-suited to receive an ongoing stream of data from a monitored electromechanical system. HDF file technology, as described at the above-referenced website, allows for fast access of nearly unlimited size data sets, which can offer a significant advantage over traditional database technology where it is anticipated that a high volume of data from one or more monitored sites 302 will be received and stored. Alternatively, data storage facility could use an RDBMS system such as a SQL server, or any other data storage and retrieval technology now known or later developed.

Where data storage facility 314 uses the HDF format, it preferably stores data in a hierarchical series of HDF files. An example of such a hierarchical series is depicted in FIG. 5, where files containing raw data from sensors 304 are broken into sites 502. Each site in turn is broken up into multiple years 504. Additionally, an analysis division 506 is also present for each site, to separate analysis results computed by analysis engine 312 from raw data received from sensors 304. Finally, each division of multiple years 504 and analysis division 506 can have multiple HDF files 508. In FIG. 5, multiple HDF files 508 are associated on a once-per-day basis for raw data, and different performed analyses for analysis division 506. A person skilled in the relevant art will appreciate that the HDF file organizational structure depicted in FIG. 5 is only one possible implementation, and a variety of organizational structures could be employed. Moreover, some analyses that may create derived data points that have a one to one correspondence with raw data could be inserted in-line with the raw data into the files storing raw data. Finally, the chosen organizational structure and method/location of storing analysis data can vary from site to site, depending upon the unique needs of each site operator.

Still further, data analysis facilities 310 may be located in separate third-party controlled data centers, where system 300 is implemented substantially as a cloud-based service. Such an example embodiment would allow for a number of disparate, separately owned sites 302 who subscribe to a monitoring and analysis service offered by an operator of system 300. Data analysis facilities 310 in such a cloud-type of implementation may be further implemented using technologies such as server virtualization, allowing for easy spin up of additional data analysis facilities 310 in a one to one correspondence to each site 302, or other advantageous ratios as the particular needs of operators of sites 302 may dictate.

The various data analysis facilities 310 are in data communication with and capable of being accessed by an interface server 316. Interface server 316 handles authentication of various users, who are typically operators of one or more sites 302. More importantly, interface server 316 provides a portal to access all information stored at the various data analysis facilities 310, including both raw data and analyses. Interface server 316 also allows for administrative functions to be carried out by owners/operators of sites 302. Such functions may include user management, where a site 302 owner/operator may designate users who can access data and analyses relevant to their site 302, or optionally make such information public, bringing additional sites 302 online, provisioning of additional data analysis facilities 310, or creating and implementing custom analyses to be performed against a site 302 by analysis engine 312. The various user credentials that allow access to system 300 are preferably stored in a separate user authentication data base (not shown in the figures) that is in data communication with interface server 316, although any method of providing access control now known or later developed could be utilized.

Interface server 316 is preferably implemented as a web service, which allows access by a web browser, although interface server 316 may be implemented as any system that allows interaction with client browser 318. Such implementations may include single servers or clusters of server, such as in a data center, depending upon the overall needs of system 300. Interface server 316 may be implemented as a standalone web server, with functionality implemented using now known or later developed web programming technologies. In the preferred embodiment interface server 316 does not directly access the various HDF files in data storage facility 314, but rather communicates with a process in data analysis facility 310 that handles reading of the HDF files. As explained above, this process that reads the HDF files may be a stand-alone process that comprises part of data storage facility 314, or may be integral with analysis engine 312.

Owners/operators of sites 302 may access system 300 via a client browser 318 that communicates with interface server 316. Client browser 318 is preferably a web browser, such as a commercially available browser like Google Chrome, Apple Safari, Firefox, or Microsoft Edge. However, in correspondence to an implementation of interface server 316, client browser 318 may optionally be a custom developed user interface, such as a dedicated app that runs on a mobile device. Where client browser 318 is implemented as a dedicated application, the protocols by which it communicates with interface server 316 can be tailored to specific system 300 needs.

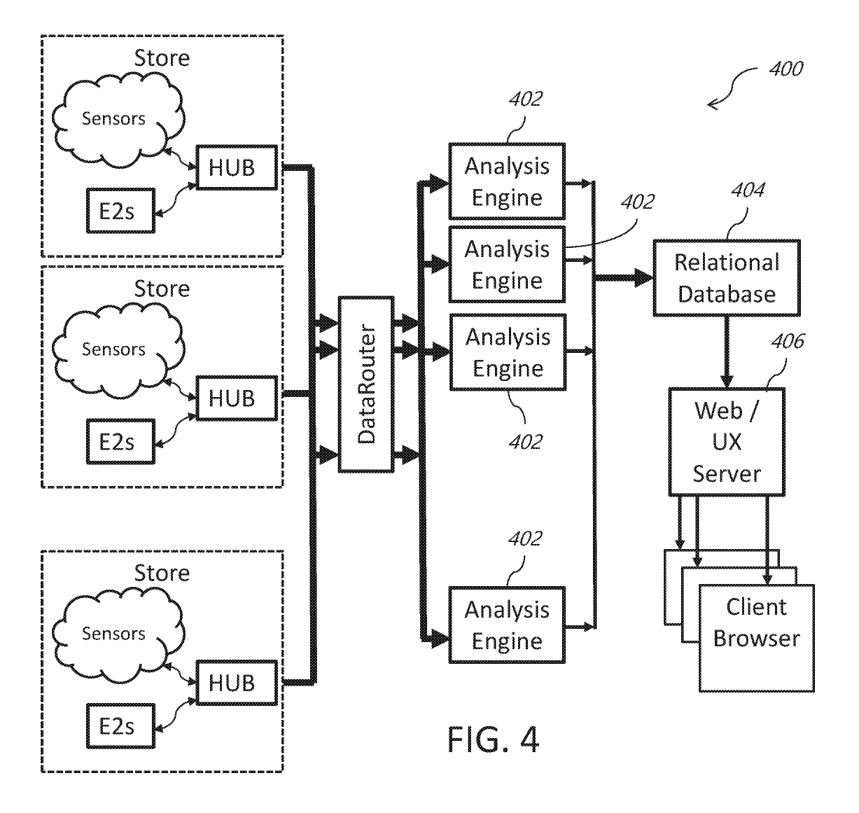

Turning attention to FIG. 4, a second example of a data storage and analysis system, system 400, will now be described. System 400 includes many similar or identical features to system 300. Thus, for the sake of brevity, each feature of system 400 will not be redundantly explained. Rather, key distinctions between system 400 and system 300 will be described in detail and the reader should reference the discussion above for features substantially similar between the two systems.

As can be seen in FIG. 4, system 400 includes similar sites, a data router, analysis engine, data storage facilities, and an interface server, corresponding to many of the same components of system 300. However and as can be seen in FIG. 4, system 400 implements a series of analysis engines 402 that stand alone, apart from the data analysis facilities 310 in system 300 that combine the analysis engine with a data storage facility.

Analysis engines 402 have identical functionality to the analysis engines 312 in FIG. 3, and preferably roughly correspond to each site on a 1:1 basis. Analysis engines 402 are in data communication with and feed both data and analyses to a single data storage facility 404. Data storage facility 404 may be implemented as relational database as labeled in FIG. 4, may be implemented as an HDF file system as described above in relation to system 300 and as disclosed in FIG. 5, or any other suitable data storage technology as may be appropriate to an implementation of system 400.

Interface server 406 has substantially identical functionality to interface server 316 of system 300. Interface server 406 is in direct data communication with data storage facility 404 to provide access to the data and analyses collected from across the various sites, as fed through analysis engines 402. As such, interface server 406 could be implemented in an integrated fashion with data storage facility 404 upon a single server or cluster of servers, or in a single data center. The separation of data storage facility 404 into a single instance, as compared to the preferred implementation of system 300 where there is a separate instance of a data storage facility 314 that corresponds to each analysis engine 312, can simplify access to desired data sets and analyses by requiring that interface server 406 only communicate with the single data storage facility 404, as opposed to multiple potential data storage facilities. However, the tradeoff of a single data storage facility 404 is an escalating load on the data storage facility 404 as the number of sites grows, which may necessitate more frequent and expensive upgrades to data storage facility 404; data storage facility accordingly lacks the easy scalability of the system 300 architecture where each analysis engine has a corresponding data storage facility.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A data storage, retrieval and analysis system for monitoring geographically distributed electromechanical systems, comprising:
one or more sites with monitored systems, each site further comprising
one or more sensors attached to the monitored systems, and
at least one hub in data communication with the one or more sensors;
at least one data router in data communication with the at least one hub at each of the one or monitored sites;
one or more data analysis facilities in data communication with the at least one data router, each data analysis facility further comprising:
an analysis engine associated with at least one of the one or more sites, and
a data storage facility corresponding to and in data communication with the analysis engine; and
an interface server in data communication with the one or more data analysis facilities;
wherein each analysis engine performs data analysis specific to its associated one or more sites, and the interface server provides access to the data analysis performed by each analysis engine.

2. The data storage, retrieval and analysis system of claim 1, wherein each of the one or more data storage facilities stores received data using an HDF file format.

3. The data storage, retrieval and analysis system of claim 1, wherein the one or more sensors output data for analysis by the analysis engine.

4. The data storage, retrieval and analysis system of claim 3, wherein each of the one or more sensors measure electrical characteristics of the monitored systems.

5. The data storage, retrieval and analysis system of claim of claim 4, wherein the monitored systems comprise refrigeration systems.

6. The data storage, retrieval and analysis system of claim 1, wherein:
the at least one data router further comprises a security mechanism with associated authentication credentials;
the data router receives authentication credentials from the at least one hub; and
the data router forwards data received from the at least one hub to the data analysis facility associated with the at least one hub if the authentication credentials received from the at least one hub match the at least one data router's associated authentication credentials.

7. The data storage, retrieval and analysis system of claim 1, wherein each data analysis facility is associated with a unique site.

8. The data storage, retrieval and analysis system of claim 1, wherein each data analysis facility is in data communication with the at least one data router via the Internet.

9. A data storage, retrieval and analysis system for analyzing the status of an electromechanical system, the data storage and analysis system comprising:
one or more sensors attached to the electromechanical system;
an analysis and storage facility that is located physically separate from the electromechanical system, and receives data from the one or more sensors; and
an interface server in data communication with the storage and analysis facility.

10. The data storage, retrieval and analysis system of claim 9, wherein the interface server is in data communication with a plurality of analysis and storage facilities that receive data from one or more sensors from a plurality of electromechanical systems.

11. The data storage, retrieval and analysis system of claim 10, wherein:
each analysis and storage facility performs analysis upon the data received from the one or more sensors; and
the interface server receives the analysis and can display it to a user upon request.

12. The data storage, retrieval and analysis system of claim 11, wherein each analysis and storage facility can perform an analysis upon data received from the one or more sensors that is specific to the attached electromechanical system.

13. The data storage, retrieval and analysis system of claim 9, wherein the analysis and storage facility is further comprised of one or more analysis engines that are in data communication with a data storage facility.

14. The data storage, retrieval and analysis system of claim 13, wherein the data storage facility is in data communication with the interface server.

15. The data storage, retrieval and analysis system of claim 13, wherein the data storage facility stores data in one or more HDF format files.

16. A data storage, retrieval and analysis system, comprising:
at least one electromechanical system that is capable of being monitored by sensors;
one or more sensors attached to the at least one electromechanical system, wherein the one or more sensors output data that corresponds to a monitored parameter of the electromechanical system;
an analysis engine in data communication with the one or more sensors so as to receive the data, and which perform an analysis upon the data that is specific to the electromechanical system's operating parameters; and
a data storage facility in data communication with the analysis engine that is capable of storing received data and analyses performed by the analysis engine.

17. The data storage, retrieval and analysis system of claim 16, further comprising an interface server in data communication with the data storage facility.

18. The data storage, retrieval and analysis system of claim 16, wherein the data storage facility is integrated with the analysis engine.

19. The data storage, retrieval and analysis system of claim 18, wherein:
the electromechanical system comprises a plurality of electromechanical systems; and
the analysis engine comprises a plurality of analysis engines;
with each of the plurality of electromechanical systems having a corresponding one of the plurality of analysis engines.

20. The data storage, retrieval and analysis system of claim 16, wherein the data storage facility stores received data and analyses in a hierarchical format using multiple HDF files.
